(19) United States
(12) Patent Application Publication
(10) Pub. No.: US 2025/0233191 A1
(43) Pub. Date: Jul. 17, 2025

(54) ELECTRODE ASSEMBLY AND RECHARGEABLE BATTERY INCLUDING THE SAME

(71) Applicant: SAMSUNG SDI CO., LTD., Yongin-si (KR)

(72) Inventors: Byunghuy CHO, Yongin-si (KR); Inseop BYUN, Yongin-si (KR); Donghui KIM, Yongin-si (KR); Junho BYEON, Yongin-si (KR)

(21) Appl. No.: 18/740,033

(22) Filed: Jun. 11, 2024

(30) Foreign Application Priority Data
Jan. 15, 2024 (KR) 10-2024-0005997

(51) Int. Cl. H01M 10/04; H01M 10/0587; H01M 50/105; H01M 50/538

(52) U.S. Cl. CPC H01M 10/0431; H01M 10/0587; H01M 50/105; H01M 50/538

(57) ABSTRACT

An electrode assembly includes a separator, a first electrode and a second electrode located with the separator therebetween and wound together with the separator. The first electrode includes a substrate including a body on which a composite layer and an insulating layer are located, and a plurality of tabs extending from one side of the body and contacting the insulating layer. A plurality of cut lines are located parallel to each other in at least one of the plurality of tabs. The plurality of cut lines are located at a distance from an edge of the tab.

### CROSS-REFERENCE TO RELATED APPLICATION

The present application claims priority to and the benefit of Korean Patent Application No. 10-2024-0005997 filed on Jan. 15, 2024, in the Korean Intellectual Property Office, the entire disclosure of which is incorporated herein by reference.

### BACKGROUND

### 1. Field

The disclosure relates to a rechargeable battery, and more particularly, to a rechargeable battery including an electrode assembly.

### 2. Description of the Related Art

Rechargeable batteries have been used for a variety of purposes, for example, as a power source for small electronic devices, such as mobile phones and laptop computers, and as a power source for driving motors in transportation vehicles, such as electric vehicles and hybrid vehicles. Rechargeable batteries basically include an electrode assembly and a case accommodating and sealing the electrode assembly, and may be classified into cylindrical batteries, prismatic batteries, and pouch-type batteries depending on their appearance.

In the process of manufacturing a jelly roll-type electrode assembly, a substrate of an electrode may be formed to have various tabs by laser machining or the like and may be moved to a mandrel by various rollers forming a winding machine. However, in the process of moving the substrate in contact with the various rollers, stress may concentrate on the tabs, which may cause damage to be tabs, such as wrinkles. Damage to the tabs may lead to fracture of the substrate, making winding of the substrate difficult or sometimes impossible.

### SUMMARY

Embodiments of the present disclosure provide an electrode assembly for minimizing or preventing damage to a tab and subsequent fracture of a substrate by reducing stress that occurs when the tab passes through a roller, and a rechargeable battery including the same.

According to an embodiment, an electrode assembly includes a separator, a first electrode, and a second electrode located with the separator therebetween and wound together with the separator. The first electrode may include a substrate including a body on which a composite layer and an insulating layer are sequentially located, and a plurality of tabs extending from one side of the body and contacting the insulating layer. A plurality of cut lines may be located parallel to each other in at least one of the plurality of tabs. The plurality of cut lines may be located at a distance from an edge of the tab.

The plurality of cut lines may be parallel to a width direction of the body and may be located at a distance from each other in a longitudinal direction of the body. The plurality of cut lines may have a same length and are located at a distance from one edge of the tab parallel to the longitudinal direction of the body and the insulating layer.

In one embodiment, the plurality of cut lines may have at least two different lengths, and a longer cut line of the plurality of cut lines may be located to be closer to a center of the tab. One end of each of the plurality of cut lines may be in contact with the insulating layer.

In one embodiment, the plurality of cut lines may be parallel to a longitudinal direction of the body and may be located at a distance from each other in a width direction of the body. The plurality of cut lines may have the same length and may be located at a distance from two edges of the tab parallel to the width direction of the body.

In one embodiment, the plurality of cut lines may have at least two different lengths, and a longer cut line of the plurality of cut lines may be located to be closer to the insulating layer. Among the plurality of cut lines, one cut line closest to the insulating layer may be in contact with the insulating layer.

According to one embodiment, an electrode assembly includes: a separator, a first electrode, and a second electrode located with the separator therebetween and wound together with the separator. The first electrode may include a body on which a composite layer and an insulating layer are sequentially located, and a plurality of tabs extending from one side of the body and contacting the insulating layer. A plurality of cut lines parallel to a width direction of the body may be located in at least one of the plurality of tabs. A first end of each of the plurality of cut lines may be in contact with the insulating layer and a second end each of the plurality of cut lines may be in contact with one edge of the tab parallel to a longitudinal direction of the body. The plurality of cut lines may be located at same intervals in the longitudinal direction of the body.

According to one embodiment, an electrode assembly includes: a separator, a first electrode, and a second electrode located with the separator therebetween and wound together with the separator. The first electrode may include a substrate including a body on which a composite layer and an insulating layer are sequentially located, and a plurality of tabs extending from one side of the body and contacting the insulating layer. A plurality of cut lines having different lengths may be located at a distance from each other in at least one of the plurality of tabs.

The plurality of cut lines may be parallel to a width direction of the body, and a longer cut line may be located to be closer to a center of the tab. The plurality of cut lines may be parallel to a longitudinal direction of the body, and a longer cut line may be located to be closer to the insulating layer.

The first electrode, the separator, and the second electrode may be wound around two winding axes to form a roll. A thickness of the insulating layer may be 30 μm or more and less than or equal to a thickness of the composite layer. According to an embodiment, a rechargeable battery includes the electrode assembly of the configuration described above and a case accommodating and sealing the electrode assembly together with an electrolyte.

### BRIEF DESCRIPTION OF THE DRAWINGS

FIG. 1 is a perspective view of an electrode assembly according to an embodiment of the present disclosure.

FIG. 2 is an enlarged view of region A shown in FIG. 1.

FIG. 3 is a plan view of an unfolded state of a first electrode and a second electrode of the electrode assembly shown in FIG. 1.

FIG. 4 is a cross-sectional view of the first electrode taken along line B-B in FIG. 3.

FIG. 5 is a cross-sectional view of the second electrode taken along line C-C in FIG. 3.

FIG. 6 is a partially enlarged view of the first and second electrodes shown in FIG. 3.

FIG. 7 is a partially enlarged view of the first electrode shown in FIG. 6.

FIG. 8 is a schematic diagram of a process of transferring the first electrode shown in FIG. 3 by a roller.

FIG. 9 is a partially enlarged view of a first electrode in an electrode assembly according to an embodiment of the present disclosure.

FIG. 10 is a partially enlarged view of a first electrode of an electrode assembly according to an embodiment of the present disclosure.

FIG. 11 is a partially enlarged view of a first electrode of an electrode assembly according to an embodiment of the present disclosure.

FIG. 12 is a partially enlarged view of a first electrode of an electrode assembly according to an embodiment of the present disclosure.

FIG. 13 is an exploded perspective view of a rechargeable battery according to an embodiment of the present disclosure.

### DETAILED DESCRIPTION

The disclosure will be described more fully hereinafter with reference to the accompanying drawings, in which embodiments of the the present disclosure are shown. As those skilled in the art would realize, the described embodiments may be modified in various different ways, all without departing from the spirit or scope of the disclosure.

A person of ordinary skill in the art would appreciate, in view of the present disclosure in its entirety, that a feature of embodiments of the present disclosure may be combined or combined with one or more other features, partially or entirely, and may be technically interlocked and operated in various suitable ways, and an embodiment may be implemented independently of one or more other embodiments, or in conjunction with the one or more other embodiments in a suitable manner, unless expressly stated or implied otherwise.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

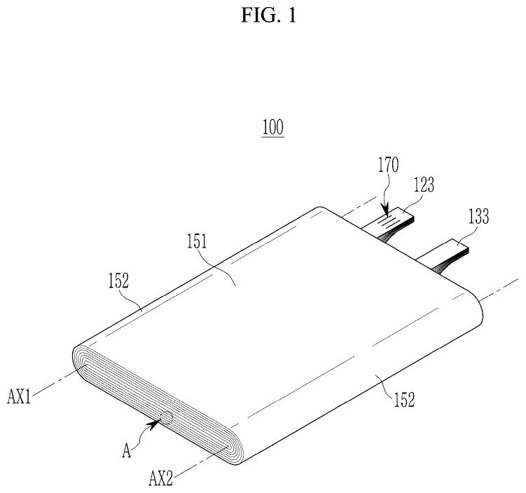

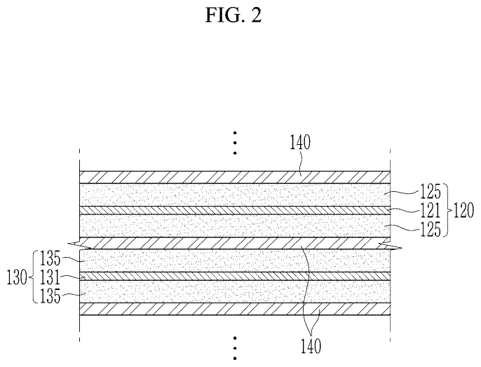

FIG. 1 is a perspective view of an electrode assembly according to an embodiment of the present disclosure, and FIG. 2 is an enlarged view of region A shown in FIG. 1.

Referring to FIGS. 1 and 2, an electrode assembly 100 may include a first electrode 120, a second electrode 130, and a separator 140. The separator 140 may be located between the first electrode 120 and the second electrode 130 to insulate them. One or more (e.g., each) of the first electrode 120, the second electrode 130, and the separator 140 may be configured in the shape of a strip (e.g., a long strip) and may be wound around two winding axes AX1 and AX2 to implement, for example, a shape of a flat jelly roll.

For example, the first electrode 120, the separator 140, the second electrode 130, and the separator 140 may be sequentially stacked to form a laminate. The laminate may be wound around a first winding axis AX1 and a second winding axis AX2 located to be spaced apart from each other. For example, the laminate may be continuously wound alternately on the first winding axis AX1 and the second winding axis AX2.

The electrode assembly 100 may include a central portion 151 (e.g., a flat, square central portion 151) and a pair of round portions 152 located on both sides of the central portion 151. The central portion 151 may be a flat portion having a certain thickness located between the first winding axis AX1 and the second winding axis AX2. The pair of round portions 152 may be semicircular curved portions respectively surrounding the two winding axes AX1 and AX2.

The first electrode 120 may include a first substrate 121 and a first composite layer 125 located on the first substrate 121. The second electrode 130 may include a second substrate 131 and a second composite layer 135 located on the second substrate 131.

In a lithium-ion rechargeable battery, the first substrate 121 may include aluminum foil, and the first composite layer 125 may include transition metal oxides, such as LiCoO₂, LiNiO₂, LiMn₂O₄, Li(NiCoAl)O₂, LiFePO₄, Li(NiCoMn)O₂, etc., conductive materials, binders, etc. The second substrate 131 may include copper foil or nickel foil, and the second composite layer 135 may include graphite, a conductive material, a binder, etc. The first electrode 120 may be referred to as a positive electrode, and the second electrode 130 may be referred to as a negative electrode.

The separator 140 may include a polymer material, such as polyethylene or polypropylene, that insulates the first electrode 120 and the second electrode 130, while allowing movement of lithium ions. In some embodiments, the electrode assembly 100 is accommodated inside a case (not shown) together with an electrolyte.

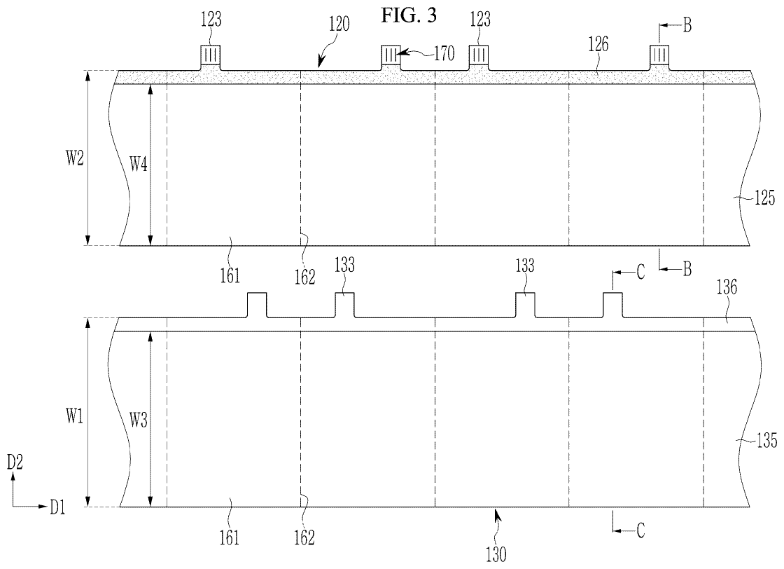

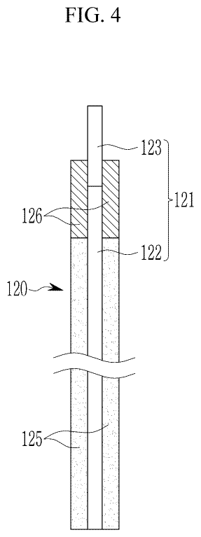

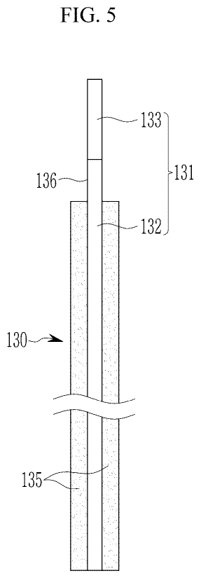

FIG. 3 is a plan view of an unfolded state of the first electrode 120 and the second electrode 130 of the electrode assembly shown in FIG. 1. FIG. 4 is a cross-sectional view of the first electrode taken along line B-B of FIG. 3, and FIG. 5 is a cross-sectional view of the second electrode taken along line C-C of FIG. 3.

Referring to FIGS. 1 to 5, the first electrode 120 and the second electrode 130 may each include a plurality of flat portions 161 corresponding to the central portion 151 and a plurality of bent portions 162 corresponding to the pair of round portions 152. The flat portion 161 and the bent portion 162 may be alternately located one by one in a longitudinal direction (a direction D1 in FIG. 3) of the first electrode 120 and the second electrode 130.

The first substrate 121 may include a first body 122 (e.g., a long strip-shaped first body 122) and a plurality of first tabs 123 extending from one side (upper side based on the drawing) of two sides of the first body 122 parallel to a longitudinal direction (the direction D1). The plurality of first tabs 123 may be located one by one on each flat portion 161 of the first substrate 121 and may overlap each other after the laminate is wound.

The first substrate 121 may be formed to have the first body 122 and a plurality of first tabs 123 by laser machining, etc., and after the laminate is wound, the plurality of first tabs 123 may be fixed integrally by welding, or the like. The first composite layer 125 may be located at a predetermined distance from one side of the first body 122 where a plurality of first tabs 123 are connected to both sides of the first body 122.

The second substrate 131 may include a long strip-shaped second body 132 and a plurality of second tabs 133 extending from one side (upper side based on the drawing) of the two sides of the second body 132 parallel to the longitudinal direction (direction D1). The plurality of second tabs 133 may be located one by one on each flat portion 161 of the second substrate 131 and may overlap each other after the laminate is wound.

The second substrate 131 may be molded to have a second body 132 and a plurality of second tabs 133 by laser machining, etc., and after the laminate is wound, the plurality of second tabs 133 may be fixed integrally by welding or the like. The second composite layer 135 may be located at a predetermined distance from one side of the second body 132, where a plurality of second tabs 133 are connected to both sides of the second body 132.

The plurality of second tabs 133 and a portion of one (upper) edge of the second body 132 may not be covered with the second composite layer 135 and the surface may be exposed. For convenience, the portion of the second body 132 whose surface is exposed so as not to be covered with the second composite layer 135 is referred to as an uncoated portion 136. In the jelly roll-type electrode assembly 100, the plurality of first tabs 123 and the plurality of second tabs 133 are located at a distance from each other.

The volume of the second electrode 130 changes when the rechargeable battery is charged and discharged. Specifically, when charging the rechargeable battery, lithium ions enter the inside of the second composite layer 135, causing the second composite layer 135 to expand, and when discharging, lithium ions escape from the second composite layer 135, causing the second composite layer 135 to shrink.

As the service life of the rechargeable battery increases, the second electrode 130 may deteriorate due to repetitive volume changes. Therefore, in consideration or anticipation of the deterioration, the second electrode 130 may be provided to have a width greater than that of the first electrode 120. For example, a width W1 (see FIG. 3) of the second body 132 measured in a width direction (direction D2) of the first electrode 120 and the second electrode 130 may be greater than a width W2 (see FIG. 3) of the first body 122, and a width W3 (see FIG. 3) of the second composite layer 135 may be greater than a width W4 (see FIG. 3) of the first composite layer 125.

In some embodiments, the longitudinal direction D1 of the first electrode 120 and the second electrode 130 coincides with the longitudinal direction of the first body 122 and the second body 132. In some embodiments, the width direction D2 of the first electrode 120 and the second electrode 130 coincides with the width direction of the first body 122 and the second body 132.

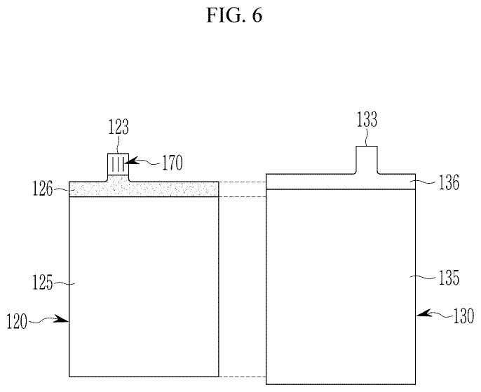

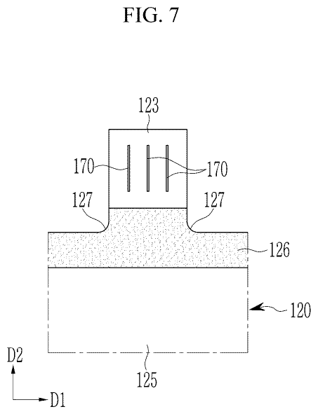

FIG. 6 is a partially enlarged view of the first electrode and the second electrode shown in FIG. 3, and FIG. 7 is a partially enlarged view of the first electrode shown in FIG. 6.

Referring to FIGS. 3 to 7, the first electrode 120 may include an insulating layer 126 located on both sides of the first body 122, and the insulating layer may be in contact with the first composite layer 125. The insulating layer 126 may be located on the edge of one side (upper side) of the first body 122 that is not covered with the first composite layer 125, and may cover the surface (e.g., the entire surface) of the first body 122 together with the first composite layer 125.

The insulating layer 126 may extend toward the first tab 123 to cover a portion of the first tab 123 in contact with the first body 122. For example, the first tab 123 may be connected to the first body 122 by a pair of curved portions 127, and the insulating layer 126 may be located to contact the pair of curved portions 127. The insulating layer 126 may overlap the uncoated portion 136 of the second electrode 130 and a portion of the second composite layer 135 with the separator 140 interposed therebetween.

In a rechargeable battery, if the first composite layer 125 and the second composite layer 135 face each other directly, a short circuit may occur. For example, in a case in which the rechargeable battery is exposed to temperatures above a threshold (e.g., high temperatures), the separator 140 may shrink and a portion of the first composite layer 125 and a portion of the second composite layer 135 may face (e.g., directly face) each other. In another example, in a case in which the first electrode 120, the separator 140, and the second electrode 130 forming the laminate are misaligned, portions of the first composite layer 125 and the second composite layer 135 may face (e.g., directly face) each other.

The insulating layer 126 may be provided on the first electrode 120 to overlap the uncoated portion 136 of the second electrode 130 and a portion of the second composite layer 135. In some embodiments, a situation in which the first composite layer 125 and the second composite layer 135 may face (e.g., directly face) each other, such as in a case in which the rechargeable battery is exposed to temperatures above the threshold (e.g., high temperatures) and the separator 140 shrinks, or in a case in which the alignment of the first electrode 120 and the second electrode 130 is off or slightly distorted during the winding process of the laminate, the insulating layer 126, instead of the first composite layer 125, faces the second composite layer 135, helping to minimize or prevent the occurrence of a short circuit.

The insulating layer 126 may contain an inorganic material. The inorganic material may be ceramics, and the ceramics may be one or more of aluminum oxide (Al₂O₃), barium titanium oxide (BaTiO₄), titanium oxide (TiO₂), and silicon oxide (SiO₂). A thickness of the insulating layer 126 may be 30 μm or more and less than or equal to a thickness of the first composite layer 125, but is not limited to this example.

In some embodiments, if the thickness of the insulating layer 126 is less than 30 μm, it may be difficult to secure sufficient insulating properties to prevent a short circuit of the first electrode 120 and the second electrode 130, and may not be easy to achieve a uniform thickness, which may increase process costs. However, if the thickness of the insulating layer 126 is greater than the thickness of the first composite layer 125, misalignment may occur during the process of winding the laminate, and the thickness of the electrode assembly 100 may become uneven, which may interfere with sealing of the case.

The strip-shaped first electrode 120 including the first composite layer 125 and the insulating layer 126 may be transported to a mandrel by a plurality of rollers constituting a winding machine and wound together with the second electrode 130 and the separator 140. When the first electrode 120 is bent in contact with a plurality of rollers, stress may concentrate on the first tab 123 due to a difference in physical properties between the insulating layer 126 and the first tab 123. This may cause damage to the first tab 123, such as the forming of wrinkles on the first tab 123. The damage to the first tab 123 may lead to fracture of the first electrode 120.

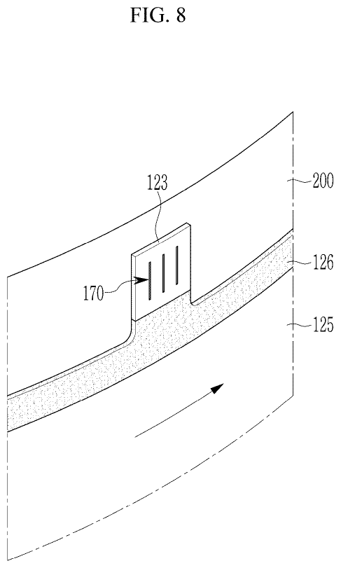

FIG. 8 is a schematic diagram of a process of transferring the first electrode shown in FIG. 3 by a roller.

Referring to FIGS. 7 and 8, in some embodiments, the first electrode 120 has a plurality of cut lines 170 to reduce stress applied to the first tab 123 when the first tab 123 is bent by the roller 200. The plurality of cut lines 170 may be located parallel to each other and may have the same length. The plurality of cut lines 170 may be located on the first tab 123 (e.g., a center of the first tab) at a distance from the three edges (upper edge and left and right edges in FIG. 7) of the first tab 123.

For example, the plurality of cut lines 170 may be located parallel to the width direction (direction D2) of the first electrode 120 and may be located away at a distance (e.g., at substantially the same distance) in the longitudinal direction (direction D1) of the first electrode 120.

One or more (e.g., each) of the plurality of cut lines 170 may be located at a distance (e.g., at substantially the same distance) from the insulating layer 126 and one (upper) edge of the first tab 123 parallel to the longitudinal direction (direction D1) of the first electrode 120. In some embodiments, one or more (e.g., the two) outermost cut lines 170 among the plurality of cut lines 170 may be located at a distance (e.g., at substantially the same distance) from the left edge and right edge of the first tab 123.

The plurality of cut lines 170 may distribute stress applied to the first tab 123 when the first tab 123 is bent in contact with the roller 200 and facilitate the bending of the first tab 123 to suppress or minimize the occurrence of wrinkles in the first tab 123. In some embodiments, when the first tab 123 contacts the roller 200, the stress may be distributed by the plurality of cut lines 170 and may be easily bent along the curvature of the roller 200, helping suppress or minimize shape deformation, such as wrinkles, on the first tab 123. The plurality of cut lines 170 may be formed by laser machining or the like.

In the electrode assembly 100 according to one embodiment of the present disclosure, damage to the first electrode 120 during the process of transferring and winding the first electrode 120 may be suppressed using the plurality of cut lines 170 located in the first tab 123, and manufacturing yield of the electrode assembly 100 may increase. Although three cut lines 170 are shown in FIGS. 7 and 8, the number of cut lines 170 is not limited to the illustrated example, and the number of cut lines may be more or less than three.

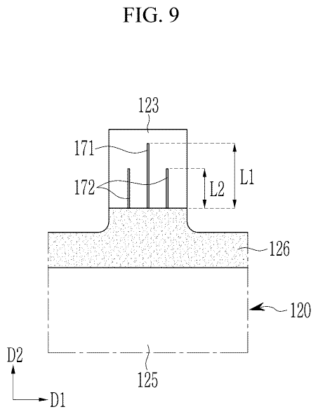

FIG. 9 is a partially enlarged view of a first electrode in an electrode assembly according to one embodiment of the present disclosure. The electrode assembly according to the embodiment of FIG. 9 has the same or similar configuration as the embodiment described above with respect to FIGS. 1-8, except for the arrangement of the cut lines described below.

Referring to FIG. 9, in one embodiment, a plurality of cut lines 171 and 172 located in the first tab 123 may have different lengths. The plurality of cut lines 171 and 172 may have at least two different lengths, and a longer cut line may be located at the center of the first tab 123.

For example, the plurality of cut lines 171 and 172 may include at least one first cut line 171 having a first length L1 and at least two second cut lines 172 having a second length L2 that is less than the first length L1. The first cut line 171 may be located closer to the center of the first tab 123 than the second cut line 172. In FIG. 9, for example, one first cut line 171 may be located at the center of the first tab 123, and two second cut lines 172 may be located on both sides of the first cut line 171.

One or more (e.g., each) of the plurality of cut lines 171 and 172 may be in contact with the insulating layer 126 and may be located away from one (upper) edge of the first tab 123 parallel to the longitudinal direction (direction D1) of the first electrode 120. The plurality of cut lines 171 and 172 in contact with the insulating layer 126 may facilitate bending of the first tab 123 portion in contact with the insulating layer 126, when the first tab 123 is bent along the curvature of the roller 200, to effectively suppressing or minimize the occurrence of wrinkles in the first tab 123.

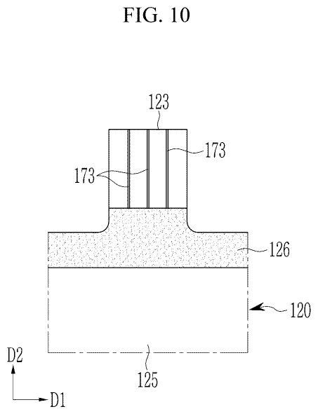

FIG. 10 is a partially enlarged view of a first electrode of an electrode assembly according to an embodiment of the present disclosure. The electrode assembly according to the embodiment of FIG. 10 has the same or similar configuration as the embodiment described above with respect to FIGS. 1-8, except for the arrangement of the cut lines described below.

Referring to FIG. 10, in one embodiment, a plurality of cut lines 173 may be located in contact with the insulating layer 126 and in contact with one (upper) edge of the first tab 123 parallel to the longitudinal direction (direction D1) of the first electrode 120. In some embodiments, the plurality of cut lines 173 may be configured to extend from the insulating layer 126 to the one (upper) edge of the first tab 123.

The plurality of cut lines 173 may divide the first tab 123 into a plurality of portions in the longitudinal direction (direction D1) of the first electrode 120. The first tab 123, which is divided into a plurality of portions by a plurality of cut lines 173, may be bent (e.g., very easily bent) as the plurality of portions are opened when bent along the curvature of the roller 200, and may suppress or minimize the occurrence of wrinkles on the first tab 123.

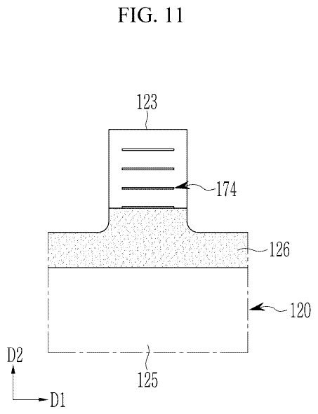

FIG. 11 is a partially enlarged view of a first electrode of an electrode assembly according to one embodiment of the present disclosure. The electrode assembly according to the embodiment of FIG. 11 has the same or similar configuration as the embodiment described above with respect to FIGS. 1-10, except for the arrangement of the cut lines described below.

Referring to FIG. 11, in one embodiment, the plurality of cut lines 174 may be located parallel to the longitudinal direction (direction D1) of the first electrode 120 and may be located at a distance from each other in the width direction (direction D2) of the first electrode 120. The plurality of cut lines 174 may have substantially the same length and may be located at a distance (e.g., at substantially the same distance) from each other. The plurality of cut lines 174 may be located at a distance from the two edges (left and right edges) of the first tab 123 parallel to the width direction (direction D2) of the first electrode 120.

Among the plurality of cut lines 174, one of the cut lines 174 (e.g., the cut line closest to the insulating layer 126) may be located in contact with the insulating layer 126. Among the plurality of cut lines 174, one of the cut lines 174 (e.g., the cut line 174 farthest from the insulating layer 126) may be located at a distance from one (upper) edge of the first tab 123 parallel to the longitudinal direction (direction D1) of the first electrode 120. In some embodiments, the plurality of cut lines 174 distribute stress of the first tab 123 when the first tab 123 is bent along the curvature of the roller 200 and facilitate bending of the first tab 123.

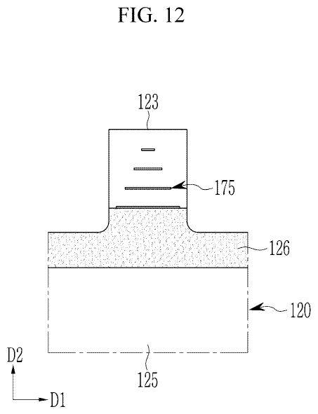

FIG. 12 is a partially enlarged view of a first electrode of an electrode assembly according to one embodiment of the present disclosure. The electrode assembly according to the embodiment of FIG. 12 has the same or similar configuration as the embodiment described above with respect to FIG. 11, except for the arrangement of the cut lines described below.

Referring to FIG. 12, in one embodiment, a plurality of cut lines 175 located on the first tab 123 may have at least two different lengths. For example, the plurality of cut lines 175 may all have different lengths. The plurality of cut lines 175 may have a greater length as they are located closer to the insulating layer 126, and one of the plurality of cut lines 175 closest to the insulating layer 126 may be located in contact with the insulating layer 126.

In some embodiments, among the plurality of cut lines 175, one cut line 175 in contact with the insulating layer 126 has the greatest length, so when the first tab 123 is bent along the curvature of the roller 200, stress at the portion of the first tab 123 in contact with the insulating layer 126 may be effectively reduced, and the portion of the first tab 123 in contact with the insulating layer 126 may be easily bent, to suppress or minimize the occurrence of wrinkles in the first tab 123.

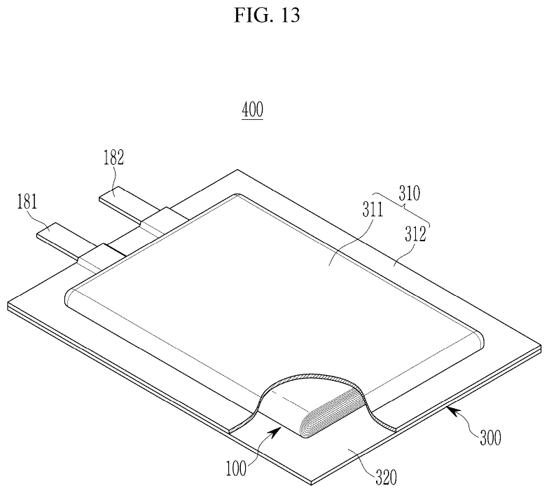

The electrode assemblies of the various embodiments described above constitute a rechargeable battery, together with the case. FIG. 13 is an exploded perspective view of a rechargeable battery according to an embodiment of the present disclosure.

Referring to FIGS. 1 and 13, a rechargeable battery 400 according to an embodiment may include an electrode assembly 100 and a pouch-type case 300 that accommodates and seals the electrode assembly 100 along with an electrolyte. The electrode assembly 100 is the electrode assembly according to any one of the various embodiments described above. The electrode assembly 100 may further include a first lead tab 181 fixed to the plurality of first tabs 123 and a second lead tab 182 fixed to the plurality of second tabs 133.

The case 300 may include an upper sheet 310 and a lower sheet 320. The upper sheet 310 may include a receiving portion 311 and a sealing portion 312 surrounding the receiving portion 311. The receiving portion 311 may be formed as a predetermined space provided in the upper sheet 310 to accommodate the electrode assembly 100. When the rechargeable battery 400 is turned upside down, the upper sheet 310 and lower sheet 320 may be referred to as a lower sheet and an upper sheet, respectively.

Portions of the first and second lead tabs 181 and 182 may overlap the sealing portion 312, and ends of the first and second lead tabs 181 and 182 may be exposed to the outside of the sealing portion 312. A protective tape (not shown) may be attached to a portion of the first and second lead tabs 181 and 182 that overlaps the sealing portion 312. After the electrode assembly 100 and the electrolyte are accommodated in the storage portion 311, the edges of the sealing portion 312 of the upper sheet 310 and the lower sheet 320 may be integrally bonded by, for example, heat fusion.

Each of the upper sheet 310 and the lower sheet 320 may include a metal sheet and a plurality of polymer sheets covering inner and outer surfaces of the metal sheet. The metal sheet may be an aluminum sheet that may increase mechanical strength of the case 300. The polymer sheet may include at least one of a polyethylene terephthalate (PET) sheet, a nylon sheet, and a PET-nylon composite sheet, and may provide insulation and protection functions to the case 300.

The rechargeable battery 400 of the above-described configuration may suppress damage to the first tab 123 and subsequent fracture of the first electrode 120 during the transfer process of the first electrode 120 for manufacturing the electrode assembly 100.

According to one or more embodiments, the plurality of cut lines 171-175 may distribute stress applied to the tab when the tab is bent in contact with the roller and may facilitate bending of the tab to help suppress or minimize the occurrence of wrinkles in the tab. In some embodiments, damage to the first electrode may be suppressed in the process of transferring and winding the first electrode, and manufacturing yield of the electrode assembly may increase.

Although exemplary embodiments of the disclosure have been described above, the disclosure is not limited thereto, and many modifications and variations will be apparent to those skilled in the art within the claim coverage, the description of the various embodiments, and the accompanying drawings, and such modifications also fall within the scope of the disclosure.

What is claimed is:

1. An electrode assembly comprising:
a separator;
a first electrode; and
a second electrode located with the separator therebetween and wound together with the separator,
wherein the first electrode includes a substrate including a body on which a composite layer and an insulating layer are sequentially located, and a plurality of tabs extending from one side of the body and contacting the insulating layer, and
wherein a plurality of cut lines are located parallel to each other in at least one of the plurality of tabs, the plurality of cut lines being located at a distance from an edge of the one of the plurality of tabs.

2. The electrode assembly of claim 1, wherein:
the plurality of cut lines are parallel to a width direction of the body and are located at a distance from each other in a longitudinal direction of the body.

3. The electrode assembly of claim 2, wherein:
the plurality of cut lines have a same length and are located at a distance from one edge of the one of the plurality of tabs parallel to the longitudinal direction of the body and the insulating layer.

4. The electrode assembly of claim 2, wherein:
the plurality of cut lines have at least two different lengths, and a longer cut line of the plurality of cut lines is located to be closer to a center of the one of the plurality of tabs.

5. The electrode assembly of claim 4, wherein:
one end of each of the plurality of cut lines is in contact with the insulating layer.

6. The electrode assembly of claim 1, wherein:
the plurality of cut lines are parallel to a longitudinal direction of the body and are located at a distance from each other in a width direction of the body.

7. The electrode assembly of claim 6, wherein:
the plurality of cut lines have a same length and are located at a distance from two edges of the one of the plurality of tabs parallel to the width direction of the body.

8. The electrode assembly of claim 6, wherein:
the plurality of cut lines have at least two different lengths, and a longer cut line of the plurality of cut lines is located to be closer to the insulating layer.

9. The electrode assembly of claim 6, wherein:
among the plurality of cut lines, one cut line closest to the insulating layer is in contact with the insulating layer.

10. An electrode assembly comprising:
a separator;
a first electrode; and
a second electrode located with the separator therebetween and wound together with the separator,
wherein the first electrode includes a substrate including a body on which a composite layer and an insulating layer are sequentially located, and a plurality of tabs extending from one side of the body and contacting the insulating layer,
wherein a plurality of cut lines parallel to a width direction of the body are located in at least one of the plurality of tabs, and
a first end of each of the plurality of cut lines is in contact with the insulating layer and a second end of each of the plurality of cut lines opposite the first end is in contact with one edge of the one of the plurality of tabs parallel to a longitudinal direction of the body.

11. The electrode assembly of claim 10, wherein:
the plurality of cut lines are located at same intervals in the longitudinal direction of the body.

12. An electrode assembly comprising:
a separator;
a first electrode; and
a second electrode located with the separator therebetween and wound together with the separator, wherein the first electrode includes a substrate including a body on which a composite layer and an insulating layer are sequentially located, and a plurality of tabs extending from one side of the body and contacting the insulating layer, and
wherein a plurality of cut lines having different lengths are located at a distance from each other in at least one of the plurality of tabs.

13. The electrode assembly of claim 12, wherein:
the plurality of cut lines are parallel to a width direction of the body, and a longer cut line is located to be closer to a center of the one of the plurality of tabs.

14. The electrode assembly of claim 12, wherein:
the plurality of cut lines are parallel to a longitudinal direction of the body, and a longer cut line is located to be closer to the insulating layer.

15. The electrode assembly of claim 1, wherein:
the first electrode, the separator, and the second electrode are wound around two winding axes to form a roll, and
a thickness of the insulating layer is 30 μm or more and less than or equal to a thickness of the composite layer.

16. The electrode assembly of claim 10, wherein:
the first electrode, the separator, and the second electrode are wound around two winding axes to form a roll, and
a thickness of the insulating layer is 30 μm or more and less than or equal to a thickness of the composite layer.

17. The electrode assembly of claim 12, wherein:
the first electrode, the separator, and the second electrode are wound around two winding axes to form a roll, and
a thickness of the insulating layer is 30 μm or more and less than or equal to a thickness of the composite layer.

18. A rechargeable battery comprising:
the electrode assembly according to claim 1; and
a case accommodating and sealing the electrode assembly together with an electrolyte.

19. A rechargeable battery comprising:
the electrode assembly according to claim 10; and
a case accommodating and sealing the electrode assembly together with an electrolyte.

20. A rechargeable battery comprising:
the electrode assembly according to claim 12; and
a case accommodating and sealing the electrode assembly together with an electrolyte.
